(19) United States
(12) Patent Application Publication
(10) Pub. No.: US 2015/0197046 A1
(43) Pub. Date: Jul. 16, 2015

(54) VEHICLE INTERIOR PART AND METHOD OF MAKING THE SAME

(71) Applicant: Ford Global Technologies, LLC, Dearborn, MI (US)

(72) Inventors: James Paul Yizze, Shelby Twp., MI (US); Bari Brown, Ann Arbor, MI (US); Charles Alan Rocco, Milford, MI (US)

(73) Assignee: Ford Global Technologies, LLC, Dearborn, MI (US)

(21) Appl. No.: 14/156,754

(22) Filed: Jan. 16, 2014

(51) Int. Cl. B29C 45/14; B29D 99/00; B32B 27/30; B29C 45/72

(52) U.S. Cl. CPC B29C 45/14; B29C 45/7207; B29D 99/0021; B32B 27/304; B29K 2101/00

(57) ABSTRACT

The present invention in one or more embodiments provides a method of forming a polymeric skin of a vehicle interior part such as an instrument panel, the method including the steps of heating a molding cavity having a shape of the vehicle interior part, injecting a polymer into the molding cavity to form the polymeric skin, and cooling the molding cavity. The heating may be carried out prior to the injecting. The heating may overlap in time with the injecting. The cooling may be carried out subsequent to the injecting. The cooling may overlap in time with the injecting. The polymeric skin may then positioned next to a cushion layer which is in turn positioned next to a substrate layer to form the vehicle interior part.

### TECHNICAL FIELD

The disclosed inventive concept relates generally to a vehicle interior part such as an instrument panel, and particularly a vehicle instrument panel with a polymeric skin formed via injection molding coupled with rapid heating and cooling.

### BACKGROUND

Vehicle instrument panels are provided with a polymeric skin supported on a foam layer to provide both the look and feel of a soft interface. According to certain existing processes, the polymeric skin may be formed by slush molding in which polymeric materials are positioned in free and random contact with a contact surface. However, there is a lack of control on the location and extent of the polymer fusion. In addition, and at least partially due to the lack of control, there are significant thickness variations across the various areas of the resultant polymeric skin.

It would thus be advantageous if vehicle instrument panels may be produced without these identified problems, particularly problems in relation to the quality of the polymer skin as formed.

### SUMMARY

The present invention in one or more embodiments provides a method of forming a polymeric skin of a vehicle interior part, the method including the steps of heating a molding cavity having a shape of the vehicle interior part, injecting a polymer into the molding cavity to form the polymeric skin, and cooling the molding cavity. The vehicle interior part may be an instrument panel, an overhead console, a door trim, and any other suitable interior parts that preferably require a soft touch surface skin.

The polymer as injected may be in a liquid form and in particular a molten liquid form. In certain instances, the polymer as injected may include less than 50 percent by weight of polyvinyl chloride.

The molding cavity may have an average thickness variation of no greater than 0.5 millimeters, 0.4 millimeters, 0.3 millimeters, or 0.2 millimeters.

The heating may be carried out prior to the injecting. The heating may overlap in time with the injecting. The cooling may be carried out subsequent to the injecting. The cooling may overlap in time with the injecting. The injecting may be carried out at two or more locations separate from each other.

The heating may be carried out at a temperature at, above or below the melting temperature of the polymer. However it is noted that temperatures for the heating may be varied according to the specific polymers used in the process. The cooling may be carried out at a temperature lower than the melting temperature of the polymer.

The polymeric skin may then be positioned next to a substrate layer, or to a cushion layer which is in turn positioned next to a substrate layer, to form the vehicle interior part. The cushion layer may be formed after the polymeric skin and the substrate layer are already formed. In certain instances, the cushion layer may be formed via foam in place (FIP) into a cavity created between the polymeric skin and the substrate layer.

The above advantages and other advantages and features will be readily apparent from the following detailed description of embodiments when taken in connection with the accompanying drawings.

### BRIEF DESCRIPTION OF THE DRAWINGS

For a more complete understanding of embodiments of this invention, reference should now be made to the embodiments illustrated in greater detail in the accompanying drawings and described below by way of examples wherein:

FIG. 1A illustratively depicts a perspective view of an instrument panel of a vehicle according to one or more embodiments of the present invention;

FIG. 1B illustratively depicts a partial cross-sectional view of the instrument panel referenced in FIG. 1A;

FIG. 2 illustratively depicts a flow chart showing example steps of a method for forming an instrument panel referenced in FIG. 1; and

FIG. 3 illustratively depicts a cross-sectional view of a molding device used in the method referenced in FIG. 2

### DETAILED DESCRIPTION OF ONE OR MORE EMBODIMENTS

As referenced in the FIGS., the same reference numerals are used to refer to the same components. In the following description, various operating parameters and components are described for different constructed embodiments. These specific parameters and components are included as examples and are not meant to be limiting.

The present invention in one or more embodiments is advantageous at least in that a vehicle interior part such as an instrument panel may be provided with relatively uniform thickness, with polymeric materials having relatively less tendencies to emit toxic fumes, and with relatively enhanced aesthetic surface feel, and/or without the need to be painted subsequently to reduce the look of lines and unevenness.

Without wanting to be limited to any particular theory, it is believed that one or more of the above-identified benefits is derived from the material and process involved in forming a polymeric skin for the vehicle interior part such as an instrument panel. As will be detailed herein else, the polymeric skin is formed via an injection molding coupled with rapid heating and cooling. In this coupled process, a well defined cavity in the injection molding potentiates the uniformity in thickness across the resultant polymeric skin. Rapid heating that may takes place before, during and/or after the injection molding step is believed to effectively reduce the flow resistance otherwise encountered in a structure cavity with limited thickness dimension. In this arrange, a synergy is obtained in that the resultant polymeric skin can be configured not only thin and with relatively greater thickness uniformity, but also with reduced weld lines. The synergy is further substantiated as the coupled method potentiates the use of polymers other than polyvinyl chloride which tends to emit unpleasant and sometimes toxic fumes.

For the ease of description and illustration, one or more embodiments of the present invention is described with a particular reference to an instrument panel as a non-limiting example of the vehicle interior part.

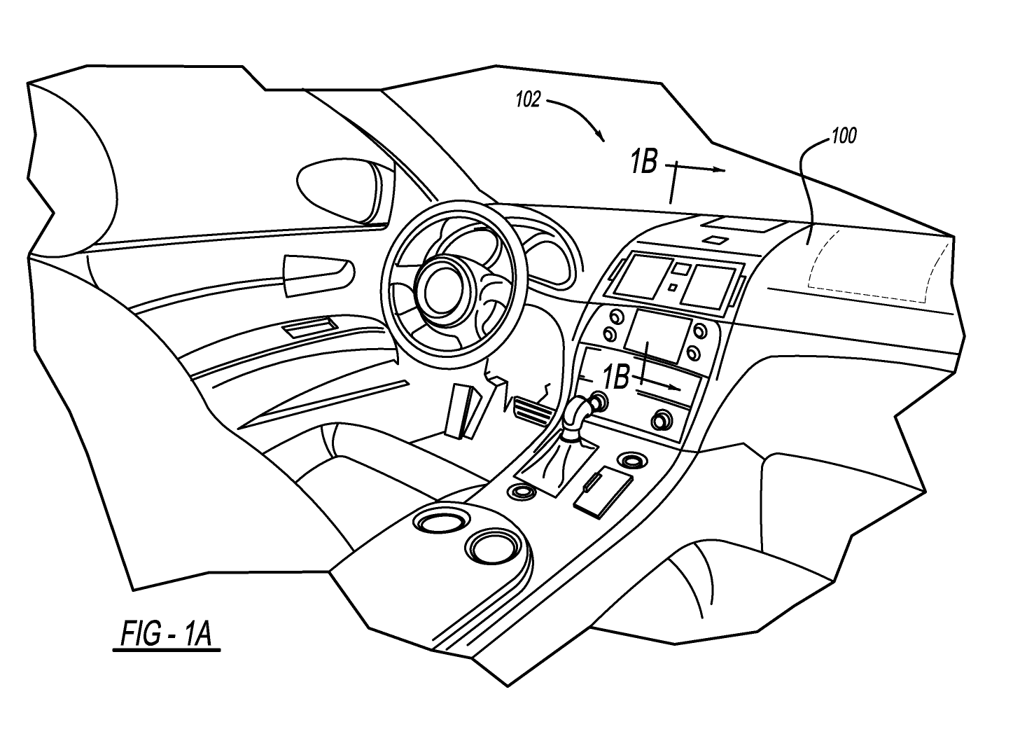

Referring now to FIG. 1A, an interior of a passenger vehicle is partially illustrated and referenced generally by the numeral 102. The interior 102 is provided with an instrument panel 100. The instrument panel 100 may be also referred as a dash or a fascia, which is a control panel placed in front of the driver of an automobile, housing instrumentation and controls for operation of the vehicle.

As illustratively depicted in FIG. 1B, the instrumental panel 100 includes a substrate layer 104, a cushion layer 106, and a polymeric skin 108, the cushion layer 106 being positioned between the substrate layer 104 and the polymeric skin 108. The substrate layer 104, the cushion layer 106 and the polymeric skin 108 may each be formed separately and independently, and then be assembled together via any suitable assembly methods. The layers 104, 106 and 108 may be assembled via adhesives and/or pressurized compression.

In certain instances, the substrate layer 104 may be preformed. The substrate layer 104 as preformed may be positioned next to the polymeric skin 108 to create a cavity or pocket in between. Source material for the cushion layer 106 may then be injected into the cavity or pocket via optionally injection molding process to form the cushion layer 106. In this arrangement, the cushion layer 106 as formed effectively functions to connect together the polymeric skin 108 and the substrate layer 104 to impart enhanced soft and smooth feel to the resultant interior part.

The substrate layer 104 may include or be formed of any suitable materials for the purpose of providing support to the overall structure of the instrument panel 100. In certain instances, the substrate layer 104 may be formed of glass fiber reinforced propylene. In certain other instances, the substrate layer 104 may include or be formed of styrene maleic anhydride (SMA). Styrene maleic anhydride is a synthetic polymer built-up of styrene and maleic anhydride monomers. The main characteristics of SMA copolymer are its transparent appearance, high heat resistance, high dimensional stability, and/or the specific reactivity of the anhydride groups. SMA is available in a broad range of molecular weights and maleic anhydride (MA) contents. Alternatively, SMA is applied using its transparency in combination with other transparent materials like poly (methyl methacrylate (PMMA) or the heat resistant polymer materials like ABS or PVC.

The cushion layer 106 may include or be formed of any suitable materials for the purpose of providing cushion to the overall structure of the instrument panel 100. In certain instances, the cushion layer 106 includes or be formed of a foam. The foam is a substance that is formed by trapping pockets of gas in a liquid or solid. In general, gas is present in large amount so it will be divided in gas bubbles of many different sizes separated by liquid regions which may form films. The term foam may also refer to anything that is analogous to a foam, such as quantum foam, polyurethane foam, foam rubber, and/or foam polystyrene.

As mentioned herein elsewhere, one of the benefits of the instrument panel 100 can offer is the reduced use or even the entire elimination in use of polyvinyl chloride, which tends to emit fumes that are environmentally unfriendly. Therefore the polymeric skin 108 of the instrument panel 100 includes less than 50%, 60%, 70%, 80%, 90%, or 99% by weight of polyvinyl chloride or any chemical variations thereof that also tend to be environmentally unfriendly.

As further mentioned herein elsewhere, the polymeric skin 108 may be formed by injection molding coupled with rapid heating and cooling such that the polymeric skin 108 may be provided with a desirably small thickness and relatively uniformity in thickness throughout.

The polymeric skin 108 may have an average thickness variation of no greater than 0.5 millimeters, 0.4 millimeters, 0.3 millimeters, or 0.2 millimeters. In certain instances, the polymeric skin 108 may be provided with an average thickness variation of less than 0.2 millimeters, less than 0.15 millimeters, or less than 0.1 millimeters. These values are advantageous at least in that certain existing methods such as slush molding cannot provide these small thickness values or these small thickness variations due to the limitations inherent to these existing methods. By way of example, slush molding lacks control as to when and where during the slush molding the polymerization may take place. As a direct result of that lack of control, certain areas of the resultant article may be provided with more polymerization and hence thicker dimensions and certain other areas may end up having premature polymer fusion and hence uneven surfaces. Therefore it is believed that the thickness values and/or the thickness uniformity that may be achieved in the polymeric skin 108 according to one or more embodiments of the present invention are advantageous and unique by being a departure from some of the existing methods and structures.

In certain instances, the polymer for forming the polymeric skin 108 includes thermoplastic vulcanizates (TPV), thermoplastic polyurethane (TPU) and/or thermoplastic elastomer (TPE). Thermoplastic polyurethane is any of a class of polyurethane plastics, which technically are thermoplastic elastomers consisting of block copolymers composed of hard and soft segments. Thermoplastic elastomers, sometimes referred to as thermoplastic rubbers, are a class of copolymers or a physical mix of polymers consisting of materials with both thermoplastic and elastomeric properties.

The polymer for forming the polymeric skin 108 may be configured as pellets and rendered as a molten liquid for downstream injection steps.

As mentioned herein elsewhere, the polymeric skin 108 may be formed via injection molding coupled with rapid heating and cooling. The general idea is to impart to the polymeric skin 108 a synergistic benefit provided by the injection molding coupled with rapid heating and cooling, wherein the injection molding potentiates the use of certain injectable polymers that do not emit irritable fumes while keeping the thickness of the resultant polymeric skin relatively small and uniformly distributed, and wherein the rapid heating and cooling reduces the difficulties associated with the injection molding due to the relatively large aspect ratio of the molding cavity.

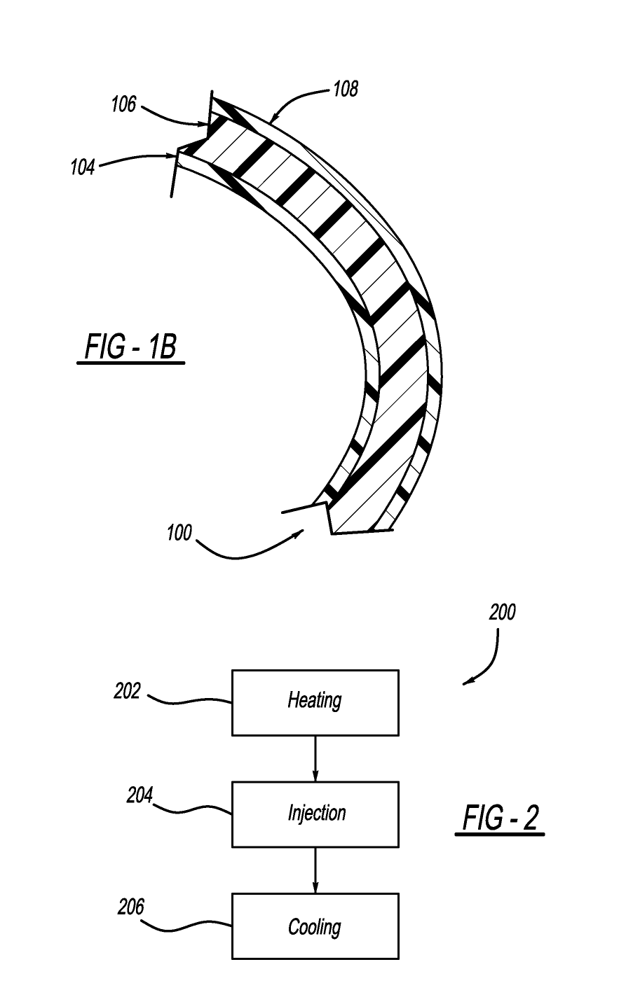

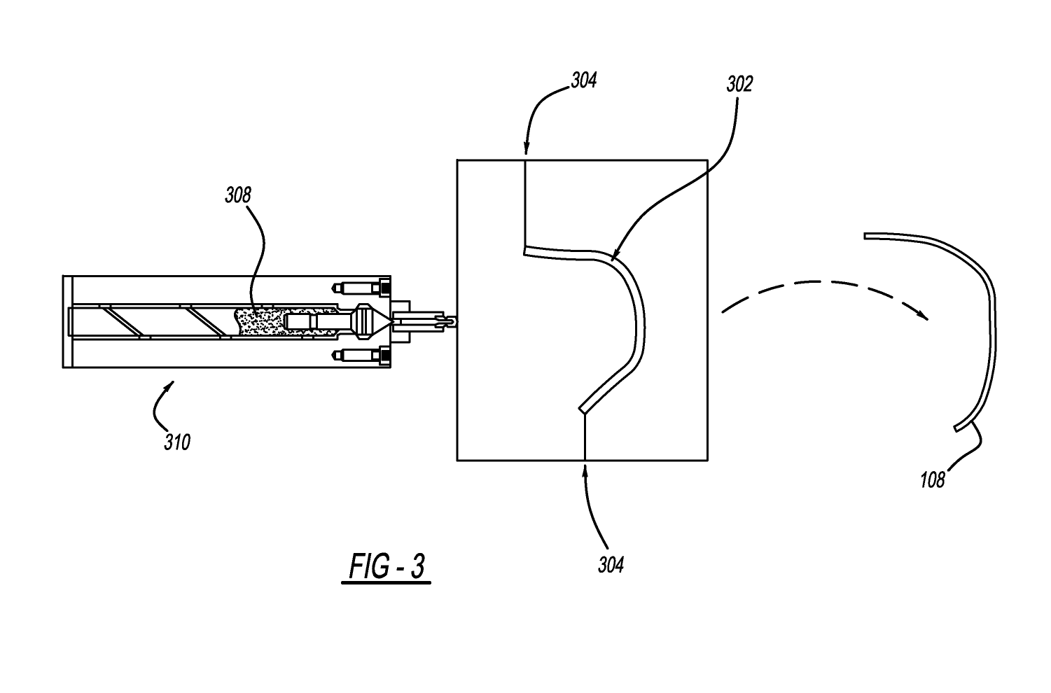

FIG. 2 illustratively depicts a non-limiting example of a method 200 of forming the instrument panel 100 and in particular the polymeric skin 108. According to the method 200 in view of FIG. 3, and at step 202, a molding cavity 302 is heated, the molding cavity 302 having a shape of the instrumental panel 100. The rapid heating may be provided via any suitable methods such as a heating rod. The molding cavity 302 is rapidly heated to a high temperature, which is at, above or below the melting temperature of the polymer to be injected into the molding cavity 302. As will be detailed herein elsewhere, the molding cavity 302 is then rapidly cooled down to solidify the shaped polymer melt in mold cavity 302 for ejection. Since the elevated mold temperature can eliminate the unwanted premature melt freezing during filling/injection stage, the melt flow resistance or injection pressure is greatly reduced and the filling ability of the polymer melt is also significantly improved. As a result, plastic parts with excellent surface appearance can be obtained. Without wanting to be limited to any particular theory, it is believed that the rapid heating helps eliminate the weld lines and reduce cycle time at least in comparison to slush molding. Because during the process of injection or filling, the molding cavity 302 is heated, the injected polymer solidifies relatively more evenly and the weld line can be minimized or eliminated.

The molding cavity 302 may be heated using any suitable methods. A non-limiting method includes the use of infrared radiation. In particular, infrared radiation may be imparted onto the molding cavity 302. Yet another non-limiting example of the method includes the use of an electric heating rod, which may be carried out in a relatively cost effective manner.

The heating may be carried out at a temperature at, above or below the melting temperature of the polymer. The heating may be carried out prior to the injecting. The heating may overlap in time with the injecting.

Rapid thermal response molding process facilitates rapid temperature change at the mold surface thereby improving quality of molded parts without increasing cycle time. The rapid heating may be carried out in any suitable heating speed and/or schedule dependent upon the particularities of the project at hand. In certain instances, the heating may be carried out at a speed of 10° F. to 30° F. per second and a target temperature may be obtained at from 225° F. to 275° F.

At step 204, a polymer 308 is injected into the molding cavity 302 via an injection molding machine 310 which optionally includes an injection gun. The injection may be carried out at one or more injection gates 304. The distance between any two injection gates 304 may be varied according to the parameters employed in the rapid heating and cooling such that weld line may be effectively reduced. Additional factors that may be used to reduce weld lines may include the geometry of the part to be formed and the flow length of the polymeric material to be injected.

At step 206, the molding cavity is cooled after the injecting step. The cooling may be carried out subsequent to the injecting. The cooling may overlap in time with the injecting. The cooling may be carried out at a temperature lower than the melting temperature of the polymer. The rapid cooling may be carried out in any suitable cooling speed and/or schedule dependent upon the particularities of the project at hand. In certain instances, the cooling may be carried out at a speed of 2.5° F. to 7.5° F. per second and a target temperature may be obtained at from 60° F. to 80° F.

### EXAMPLE

In a non-limiting example, the rapid heating is provided via induction heating with the heating power of 150 kilowatts. The heating is carried out from about 70° F. to 250° F. in about 8 seconds. After the target heating temperature of about 250° F. is obtained, the induction wires are powered off and the water cooling causes the temperature to cool back down to 70° F. in about 40 seconds.

In one or more embodiments, the disclosed invention as set forth herein overcomes the challenges faced by known production of vehicle interior parts such as instrument panels. However, one skilled in the art will readily recognize from such discussion, and from the accompanying drawings and claims that various changes, modifications and variations can be made therein without departing from the true spirit and fair scope of the invention as defined by the following claims.

What is claimed is:

1. A method of forming a polymeric skin of a vehicle interior part, comprising:
heating a molding cavity having a shape of the vehicle interior part;
injecting a polymer into the molding cavity to form the polymeric skin; and
cooling the molding cavity.

2. The method of claim 1, wherein the polymer is injected as a liquid.

3. The method of claim 1, wherein the molding cavity has an average thickness variation of no greater than 0.5 millimeters.

4. The method of claim 1, wherein the heating is carried out prior to the injecting.

5. The method of claim 1, wherein the heating overlaps in time with the injecting.

6. The method of claim 1, wherein the cooling is carried out subsequent to the injecting.

7. The method of claim 1, wherein the cooling overlaps in time with the injecting.

8. The method of claim 1, wherein the injecting is carried out at two or more locations separate from each other.

9. The method of claim 1, wherein the heating is carried out at a temperature at, below or above the melting temperature of the polymer.

10. The method of claim 1, wherein the cooling is carried out at a temperature lower than the melting temperature of the polymer.

11. The method of claim 1, wherein the polymer as injected includes less than 50 percent by weight of polyvinyl chloride.

12. A vehicle interior part comprising:
a substrate layer; and
a polymeric skin positioned next to the substrate layer and including a polymer and less than 50% by weight of polyvinyl chloride, the cushion layer being positioned between the substrate layer and the polymeric skin.

13. The vehicle interior part of claim 12, wherein the polymeric skin includes at least one of thermoplastic vulcanizates (TPV) and thermoplastic elastomer (TPE).

14. A method of forming a vehicle interior part, comprising:
forming a polymeric skin of the vehicle interior part, including heating a molding cavity having a shape of the vehicle interior part, injecting a polymer into the molding cavity to form the polymeric skin, and cooling the molding cavity; and
positioning a cushion layer and a substrate layer next to the polymeric skin, the cushion layer being positioned between the polymeric skin and the substrate layer.

15. The method of claim 14, wherein the cushion layer is formed after the polymeric skin and the substrate layer are formed.

16. The method of claim 15, wherein the cushion layer is formed by injection molding into a cavity formed between the polymeric skin and the substrate layer.

17. The method of claim 14, wherein the heating is carried out prior to the injecting.

18. The method of claim 14, wherein the heating overlaps in time with the injecting.

19. The method of claim 14, wherein the cooling is carried out subsequent to the injecting.

20. The method of claim 14, wherein the cooling overlaps in time with the injecting.
